(19) United States
(12) Patent Application Publication
(10) Pub. No.: US 2025/0073112 A1
(43) Pub. Date: Mar. 6, 2025

(54) HANDHELD SINGLE-LEG WALKER

(71) Applicant: Ningbo Chaoyi Intelligent Technology Co., Ltd, Zhejiang (CN)

(72) Inventor: Naixi Li, Zhejiang (CN)

(73) Assignee: Ningbo Chaoyi Intelligent Technology Co., Ltd, Zhejiang (CN)

(21) Appl. No.: 18/461,243

(22) Filed: Sep. 5, 2023

(51) Int. Cl. A61H 3/00

(52) U.S. Cl. CPC A61H 3/00; A61H 2003/005; A61H 2201/0107; A61H 2201/0192

(57) ABSTRACT

The present invention discloses a handheld single-leg walker, the walker includes an outrigger platform and a central support rod attached to both sides of the outrigger platform, with punched holes at the upper and lower ends of the central support rod, and clasps on the upper support rod and the curved support rod, the curved support rod is provided with pad between them and the lower support rod, and they are bolted to the lower support rod. When the second snap of the upper support rod is pressed, the upper support rod can be separated from the central support rod, and when the third snap of the curved support rod is pressed, it is possible to separate the lower support rod from the central support rod and to fold the lower support rod with the curved support rod toward the outrigger platform stowage.

### TECHNICAL FIELD

The present invention relates to the field of crutches and, in particular, to the field of a handheld single-leg walker.

### BACKGROUND

Single-leg walker is an important aid for some special people to walk, at the same time, the existing single-leg walker has a large volume, not easy to carry, difficult to dismantle, not conducive to transport, not comfortable for the user to hold and some other inconveniences, and the bottom of the foot of single-leg walker is prone to slippery, there is a potential safety hazard, so we propose a handheld single-leg walker to solve the above problems.

### SUMMARY

It is an object of the present invention to provide a handheld single-leg walker field to address the above deficiencies in the background art.

In order to achieve the above purpose, the present invention provides the following technical solution: a hand-held single-leg walker comprising outrigger platform, and central support rod connected to both sides of outrigger platform, the central support rod is detachably connected to upper support rod at the upper end, the central support rod is detachably connected to the curved support rod at the lower end, the upper support rod is connected to the removable handle, and the user holds the removable handle in hand while walking, the upper support rod is provided with the first fastener, the height of which can be adjusted to assist the user to walk, the first fastener is connected to the first connector at the other end, the first connector is connected to the first lanyard at the other end, and the first lanyard is coupled to the first pad at the other end, the curved support rod is curved, the outrigger platform is provided with a projection in the lower part, the lower support rod is pivotally coupled to the projection of the outrigger platform.

The central support rod is provided with second punch at the upper end opposite to the lower end, the upper support rod is provided with first snap, the curved support rod is provided with third snap, the first snap is detachably snap-fit in second punch at the upper end of the central support rod, the third snap is detachably snap-fit in the second punch at the lower end of the central support rod, second punch at the lower end of the central support rod, the upper support rod and the curved support rod removably snap together in the second punch of the central support rod.

The upper support rod is provided with a first punch, the removable handle is provided with a first snap, the first snap of the removable handle can be detachably snapped into the first punch of the upper support rod in order to change the length of the projection of the removable handle to adapt to different heights of the user.

Adjusting the length of the first lanyard, a space is formed between the first pad and the upper support rod to accommodate thighs.

A pad is provided between the lower support rod and the lower support rod, the bolt passes through the through-hole in the side wall of the lower support rod and connects with pad, fixing and connecting the curved support rod with the lower support rod, and the lower support rod rotates around a rotary axis, driving the curved support rod and the support seat to rotate and fold in the direction of the outrigger platform, facilitating the mounting, folding and dismounting of the single-leg walker.

Compared with the existing technology, the present invention has the following beneficial effects: the hand-held unipedal walker provided by the present invention exists in a small volume and is easy to carry, and the components of this walker can be contracted and folded, which is convenient for transportation, and the height of the removable handle can be adjusted to suit different groups of people who use it, and the bottom of the foot of the hand-held unipedal walker is provided with a non-slip pad, which prevents the occurrence of safety hazards, and there is the armrest glove on the removable handle, which gives the user a more comfortable using experience.

### BRIEF DESCRIPTION OF DRAWINGS

In order to better explain the technical scheme of this application, the drawings required for implementation are briefly introduced below. Obviously, the drawings described below are only some implementations of this application. Those skilled in the art will be able to derive other drawings from these drawings without creative effort.

FIG. 1 is a three-dimensional view of the handheld single-leg walker I;

FIG. 2 is a three-dimensional view of the handheld single-leg walker II;

FIG. 3 is a front view of handheld single-leg walker;

FIG. 4 is a right view of handheld single-leg walker;

FIG. 5 is a rear view of handheld single-leg walker;

FIG. 6 is a three-dimensional view of the handheld single-leg walker without a central support rod;

FIG. 7 is a detailed view of the structure of the lower connecting rod and abutment;

FIG. 8 is a detailed view of the structure of the removable handle;

FIG. 9 is a detailed view of the structure of the removable handle and upper support rod;

In the drawings:
1, outrigger platform; 2, removable handle; 3, upper support rod; 4, central support rod; 5, curved support rod; 6, lower support rod; 7, lower connecting rod; 8, support seat; 9, pad; 10, projection; 11, third fastener; 12, third connection; 13, third lanyard; 14, third pad; 15, fourth fastener; 16, fourth connector; 17, fourth lanyard; 18, fourth pad; 19, outrigger platform pad; 21, handholding glove; 22, first snap; 31, first fastener; 32, first connector; 33, first lanyard; 34, first pad; 35, second fastener; 36, second pad; 38, second snap; 39, first punch; 41, second punch; 51, third snap; 61, third punch; 71, fourth snap; 81, first screwing sleeve; 91, second screwing sleeve; 100, non-slip pat.

### DESCRIPTION OF EMBODIMENTS

While various aspects and features of certain embodiments have been summarized above, the following detailed description will illustrate some exemplary embodiments in more detail to enable those skilled in the art to practice such embodiments. Reference will now be made in detail to embodiments of the inventive concept, examples of which are illustrated in the accompanying drawings. The accompanying drawings are not necessarily drawn to scale. The examples described are for illustrative purposes only and are not intended to limit the scope of the invention. However, it should be understood that persons having ordinary skill in the art may practice the inventive concept without these specific details.

It will be understood that although the terms first, second, etc. may be used herein to describe various elements, these elements should not be limited by these terms. These terms are used only to distinguish one element from another. For example, a first attachment may be referred to as a second attachment, and similarly a second attachment may be referred to as a first attachment, without departing from the scope of the inventive concept.

It will be appreciated that when an element or layer is described as being “on”, “coupled” or “connected” to another element or layer, it may be directly on, directly coupled or directly connected to the other element or layer, or there may be intervening elements or layers. Conversely, when an element is described as ‘directly on’, ‘directly coupled’ or ‘directly connected’ to another element or layer, there are no intervening elements or layers. Identical numbers refer to identical elements throughout. As used herein, the term “and/or” includes any combination of one or more of the associated listed items.

As used in the description of the inventive concept and the appended claims, the singular forms “a”, “an” and “the” are intended to include the plural forms unless the context clearly indicates otherwise.

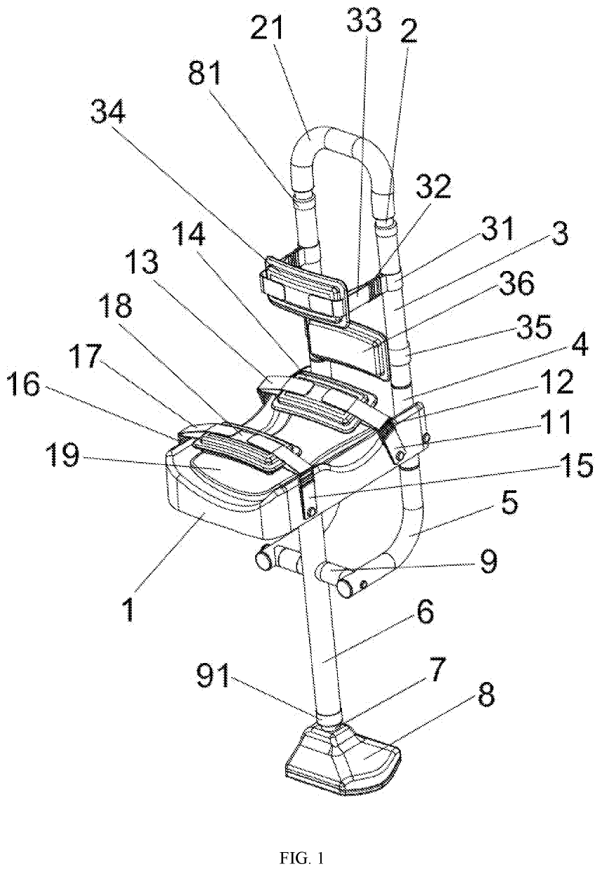

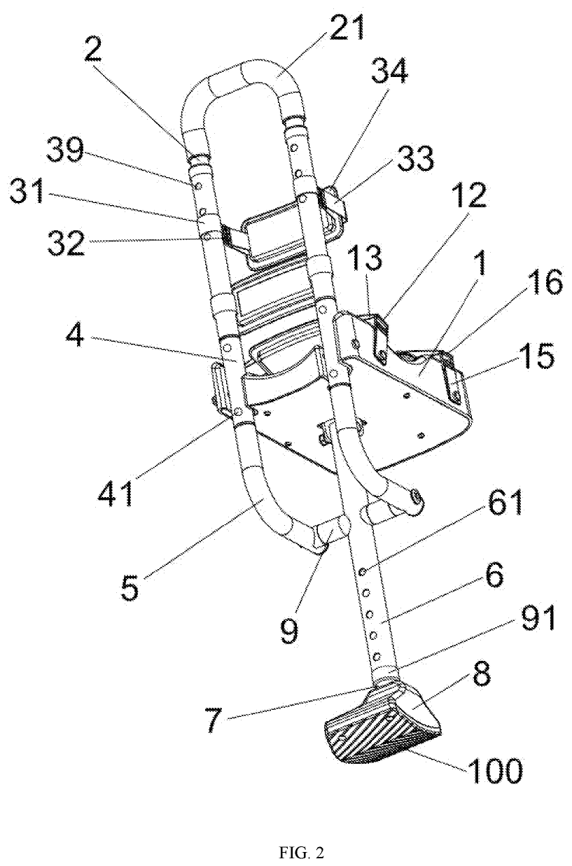

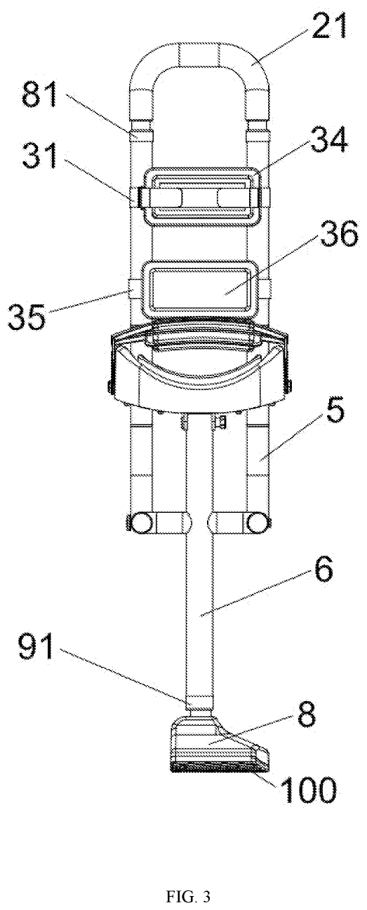

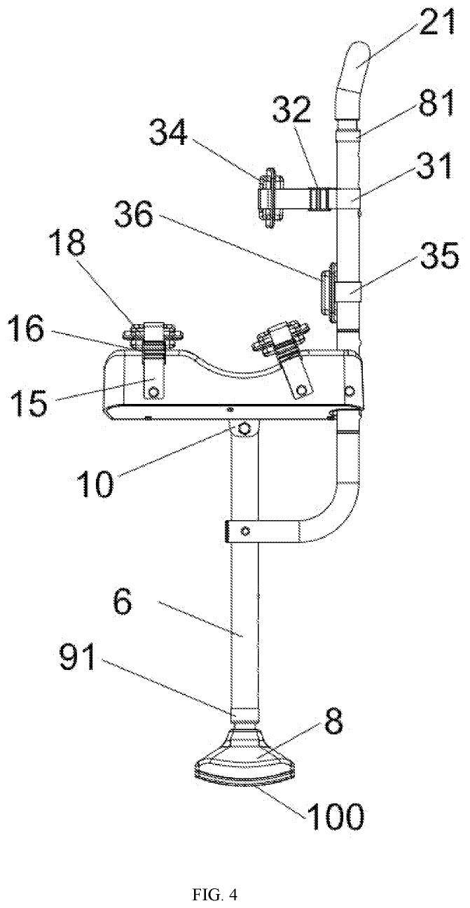

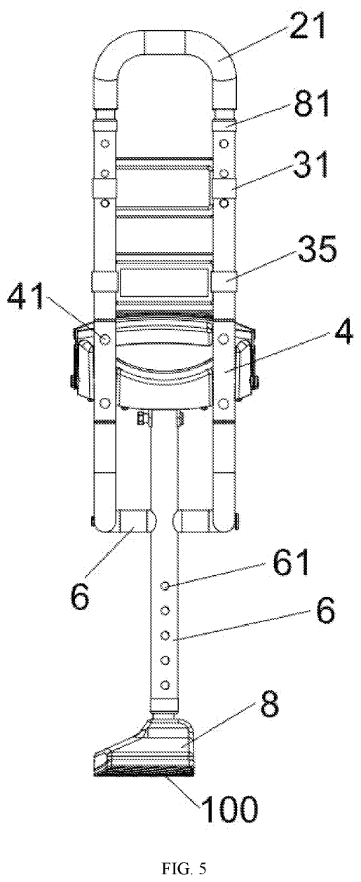

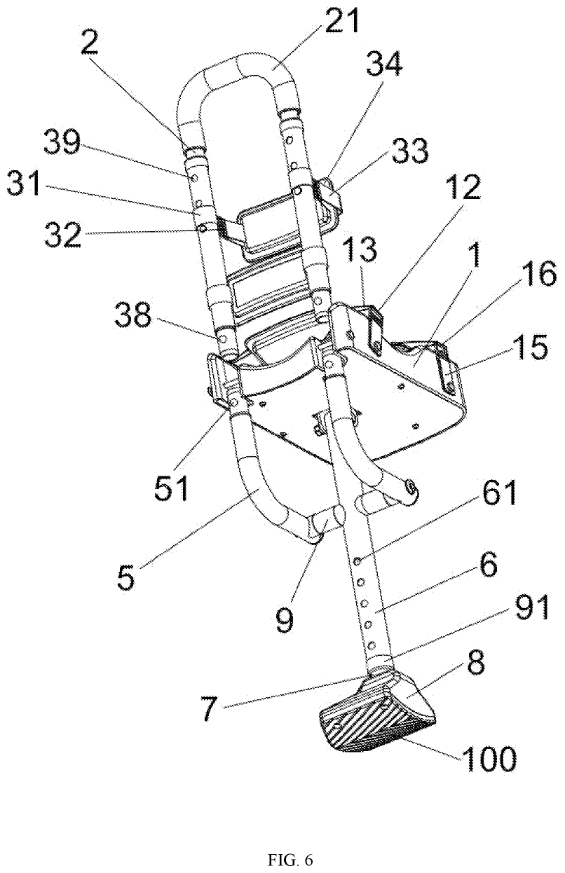

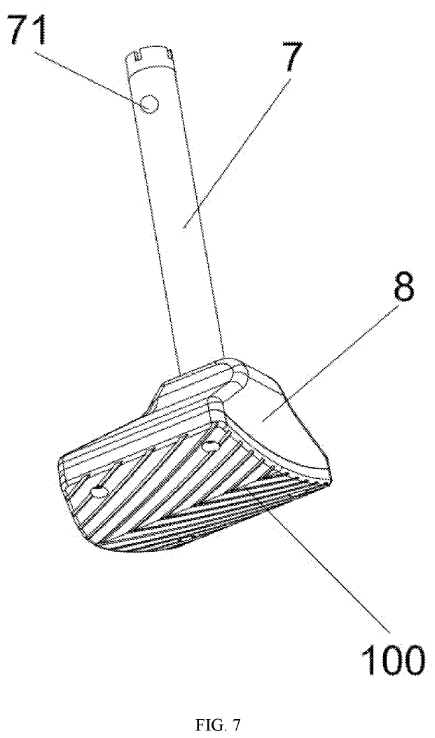

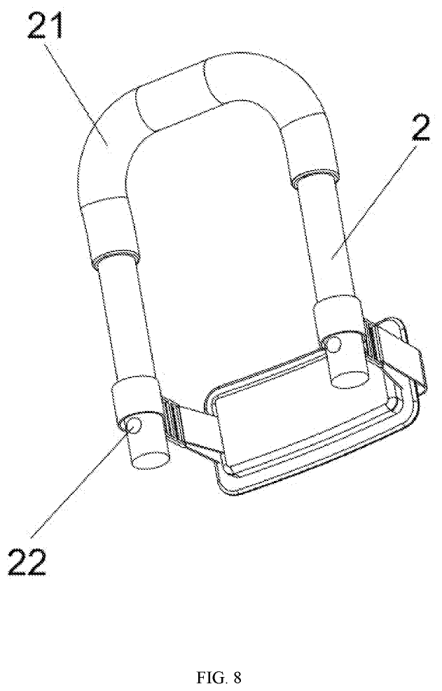

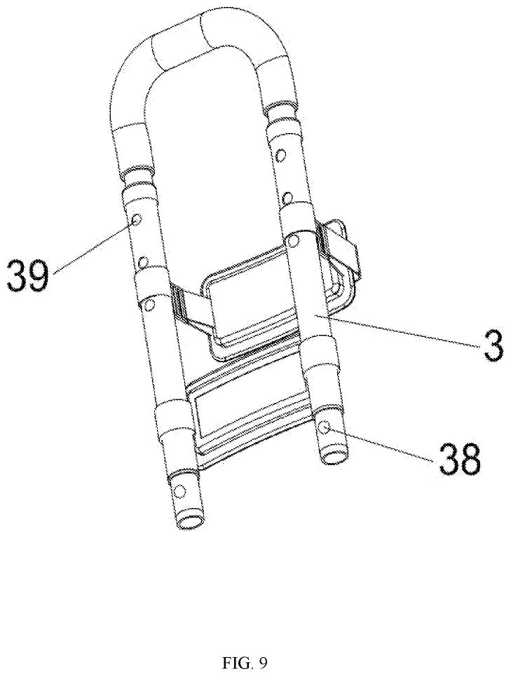

As shown in FIGS. 1 to 9, The present invention provides a handheld single-leg walker, wherein it comprises outrigger platform 1, and central support rod 4 connected to both sides of outrigger platform 1, the central support rod 4 is detachably connected to upper support rod 3 at the upper end, the central support rod 4 is detachably connected to curved support rod 5 at the lower end, and the upper support rod 3 is connected to removable handle 2, and the user holds removable handle 2 in hand while walking, the height of which can be adjusted to assist the user to walk, the upper support rod 3 is provided with first fastener 31, the first fastener 31 is connected to first connector 32 at the other end, the first connector 32 is connected to first lanyard 33 at the other end, and the first lanyard 33 is coupled to the first pad 34 at the other end, the curved support rod 5 is curved, the lower part of outrigger platform 1 is provided with projection 10, the lower support rod 6 is pivotally coupled with the projection 10 of the outrigger platform 1, and the outer side of outrigger platform 1 is recessed inwardly with a downwardly recessed curved support part, and the downwardly recessed curved support portion for supporting the legs of the user.

Wherein the single-leg walker further comprises removable handle 2, the removable handle 2 is provided with first snap 22, the upper support rod 3 is provided with first punch 39, and the first snap 22 can be pressed downward to snap the first snap 22 of the removable handle 2 in the first punch 39 of the different positions of the upper support rod 3, so as to change the length of the outstretched of the removable handle 2 to adapt to the users of different heights, and to give the users a better experience of using the device.

Wherein the first punch 39 is provided at least one on the upper support rod 3, first punch 39 being provided uniformly along the length of upper support rod 3 from the upper end of the upper support rod 3 to the lower end of the upper support rod 3.

Wherein the lower support rod 6 is provided with a cavity and the lower support rod 6 is provided with a lower connecting rod 7 sleeved inside the cavity.

Wherein the lower support rod 6 is provided with a third punch 61, the lower connecting rod 7 is provided with a fourth snap 71 corresponding to the third punch 61, and the fourth snap 71 on the lower connecting rod 7 can be snapped into the third punch 61 at different locations on the lower support rod 6 to change the length of the lower connecting rod 7 extending out.

Wherein the lower support rod 6 is provided with at least one third punch 61, the third punch 61 being evenly disposed along the length of the lower support rod 6 from the upper end of the lower support rod 6 to the lower end of the lower support rod 6.

Wherein, the lower connecting rod 7 is connected to the support seat 8, and the support seat 8 is provided with non-slip pad 100 at the lower end, and non-slip pad 100 preferably includes rubber, plastic, silicone and the like to make the user less likely to slip when using the detachable handle.

Wherein the single-leg walker is further provided with first pad 34, first lanyard 33, first fastener 31, first connector 32 on both sides, the first fastener 31 socketed at the upper end of the upper support rod 3, the first connector 32 connected to the first lanyard 33 at one end and the first fastener 31 at the other end, and the first pad 34 coupled and connected to the first lanyard 33.

Wherein the single-leg walker is further provided with second pad 36, second fastener 35 on both sides of the single-leg walker, the second fastener 35 socketed at the lower end of the upper support rod 3, and the second pad 36 coupled to the second fastener 35.

Wherein, both sides of the outrigger platform 1 further comprise third pad 14, third lanyard 13, third connector 12, third fastener 11, the third fastener 11 is fixed to the side wall of the outrigger platform 1 at one end, and the other end is connected to the third connector 12, one end of the third lanyard 13 is connected to the third connector 12, and the other end of the third lanyard 13 is coupled and connected to the third pad 14.

Wherein, both sides of the outrigger platform 1 further comprise a fourth pad 18, a fourth lanyard 17, a fourth connector 16, and a fourth fastener 15, the fourth fastener 15 being fixed to the side wall of the outrigger platform 1 at one end, and connected to the fourth connector 16 at the other end, the fourth lanyard 17 being connected to the fourth connector 16 at one end, the fourth lanyard 17 being coupled and connected to the fourth pad 18 at the other end.

Wherein among all the suitable materials for the support rod include aluminum, steel, composites, hard plastics, to provide higher strength to meet the different weight of the people who use it.

wherein, when the leg needs to be supported, first loosening first lanyard 33, the first pad 34 and the second pad 36 to form a space to accommodate the thigh, loosening third lanyard 13 and the fourth lanyard 17, third pad 14, fourth pad 18, and outrigger platform 1 to form a space to accommodate the calf, adjusting the degree of elasticity of the respective lacing to hold the lower leg to the outrigger platform 1, tightening the thigh to the second pad 36, and securing the thigh in the space to accommodate the thigh formed by the third pad 14, fourth pad 18, and upper support rod 3.

wherein the first pad 34, the second pad 36, the third pad 14 and the fourth pad 18 are made of a flexible material.

Wherein, the one-legged walker further comprises handholding glove 21, the handholding glove 21 is set on the upper end of the removable handle 2, and the handholding glove 21 is provided with non-slip pad to prevent the user's hand from slipping and resulting in safety hazards, and to give the user a better feeling of using the device.

Wherein the single leg walker comprises outrigger platform pad 19, the outrigger platform pad 19 being coupled to the outrigger platform 1, the outrigger platform pad 19 being made of a flexible material.

Wherein all suitable materials for the outrigger platform pad 19 include cellulose, sponge, silicone, rubber, latex, plastic, foam, polyester fiber, composites, and the like.

Wherein the curved support rod 5 is provided with pad 9 between the lower support rod 6, the bolt passes through a through hole with the lower support rod 6 side wall and the pad 9, fixing and connecting the curved support rod 5 with the lower support rod 6, and the lower support rod 6 rotates around a rotary axis, driving the curved support rod 5 with the support seat 8 to rotate and fold in the direction of the outrigger platform 1, which is convenient for the mounting, folding and dismounting of the single-leg walker.

Wherein the first screwing sleeve 81 is set on the top of the upper support rod 3, the first screwing sleeve 81 increases the contact area between the upper support rod 3 and the removable handle 2, increases the friction, makes the direct fit between the upper support rod 3 and the removable handle 2 closer, and makes the structure of the single-leg walker more stable.

Wherein the second screwing sleeve 91 is socketed at the bottom of the lower support rod, the second screwing sleeve 91 increases the contact area between the lower support rod 6 and the lower connecting rod 7, increases the friction force, and makes the fit between the lower support rod 6 and the lower connecting rod 7 tighter, so as to make the structure of the single-leg walker more stable.

Wherein the handholding glove 21 is made of a flexible material, all suitable materials for the handholding glove 21 include polyurethane, rubber, cellulose, silicone, sponge, plastic, composites, fabric, and the like.

Wherein, pressing the first snap 22 of the removable handle 2 adjusts the outstretched length of the removable handle 2 to accommodate people of different heights; and pressing the fourth snap 71 of the lower connecting rod 7 adjusts the outstretched length of the lower connecting rod 7 to accommodate people of different heights;

Wherein pressing the second snap 38 of the upper support rod 3 separates the upper support rod 3 from the central support rod 4, and pressing the third snap 51 of the arcuate support rod 5 separates the lower support rod 6 from the central support rod 4, with the lower support rod 6 rotating around a rotating axis to fold the lower support rod 6 together with the arcuate support rod 5 toward the outrigger platform.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

What is claimed is:

1. A handheld single-leg walker, wherein it comprises outrigger platform, and central support rod connected to both sides of outrigger platform, said central support rod is detachably connected to upper support rod at the upper end, said central support rod is detachably connected to curved support rod at the lower end, said upper support rod is connected to removable handle, and the user holds removable handle in hand while walking, said upper support rod is provided with first fastener, the height of which can be adjusted to assist the user to walk, said first fastener is connected to first connector at the other end, said first connector is connected to first lanyard at the other end, and said first lanyard is coupled to the first pad at the other end, said curved support rod is curved, said outrigger platform is provided with a projection in the lower part, said lower support rod is pivotally coupled to said projection of said outrigger platform.

2. A handheld single-leg walker according to claim 1, wherein said lower support rod is provided with a cavity, and said lower support rod is provided with a lower connecting rod sleeved within the cavity.

3. A handheld single-leg walker according to claim 2, wherein said lower support rod is provided with a third punch, said lower connecting rod is provided with a fourth snap corresponding to the third punch, and said fourth snap on said lower connecting rod can be detachably snapped in said third punch at different positions of said lower support rod, to change the length of the outstretched of the lower connecting rod.

4. A handheld single-leg walker according to claim 3, wherein said lower support rod is provided with at least one said third punch, said third punch being provided from the upper end of said lower support rod to the lower end of said lower support rod.

5. A handheld single-leg walker according to claim 4, wherein said lower connecting rod is connected to said support seat and said support seat is provided with a non-slip pad at the lower end.

6. A handheld single-leg walker according to claim 1, wherein said first fastener is socketed at the upper end of said two sides upper support rod, said first connector is connected to said first lanyard at one end, the other end is connected with the first fastener, and said first pad is coupled to said first lanyard.

7. A hand-held single-leg walker according to claim 6, wherein the length of the connection between said first lanyard and first connector is adjustable.

8. A handheld single-leg walker according to claim 7, wherein said single-leg walker is further provided with second pad, said second fastener socketed at the lower end of said upper support rod, and said second pad is coupled and connected to said second fastener.

9. A handheld single-leg walker according to claim 8, wherein both sides of said outrigger platform further comprise third pad, third lanyard, third connector, third fastener, one end of said third fastener being fixed to the side wall of said outrigger platform, and the other end being connected to said third connector, one end of said third lanyard being connected to said third connector, and the other end of said third lanyard coupling to said third pad.

10. A handheld single-leg walker according to claim 9, wherein both sides of said outrigger platform further comprise a fourth pad, a fourth lanyard, a fourth connector, a fourth fastener, one end of said fourth fastener being secured to the side wall of said outrigger platform, the other end of connected to said fourth connector, one end of said fourth lanyard is connected to said fourth connector and the other end of said fourth lanyard is coupled to said fourth pad.

11. A handheld single-leg walker according to claim 10, wherein said first pad, said second pad, said third pad and said fourth pad are made of a flexible material.

12. A handheld single-leg walker according to claim 11, wherein said first lanyard, said third lanyard and said fourth lanyard are made of nylon or polyester fibers and the like.

13. A hand-held single-leg walker according to claim 1, wherein said hand-held single-leg walker further comprises handrail glove, said handrail glove being set on the upper end of said removable handle.

14. A hand-held single-leg walker according to claim 13, wherein said handrail glove is made of rubber, cellulose, silicone, sponge, plastic, composite material and the like.

15. A handheld single-leg walker according to claim 1, wherein said single-leg walker further comprises outrigger platform pad, said outrigger platform pad being coupled to said outrigger platform, said outrigger platform pad being made of a flexible material.

16. A handheld single-leg walker, wherein it comprises outrigger platform, and central support rod connected to both sides of outrigger platform, said central support rod is detachably connected to upper support rod at the upper end, said central support rod is detachably connected to curved support rod at the lower end, said upper support rod is connected to removable handle, and the user holds removable handle in hand while walking, said upper support rod is provided with first fastener, the height of which can be adjusted to assist the user to walk, said first fastener is connected to first connector at the other end, said first connector is connected to first lanyard at the other end, and said first lanyard is coupled to the first pad at the other end, said curved support rod is curved, said outrigger platform is provided with a projection in the lower part, said lower support rod is pivotally coupled to said projection of said outrigger platform,
said central support rod is provided with second punch at the upper end opposite to the lower end, said upper support rod is provided with first snap, said curved support rod is provided with third snap, said first snap is detachably snap-fit in second punch at the upper end of said central support rod, said third snap is detachably snap-fit in the second punch at the lower end of said central support rod, second punch at the lower end of said central support rod, said upper support rod and said curved support rod removably snap together in the second punch of the central support rod;
said upper support rod is provided with a first punch, said removable handle is provided with a first snap, said first snap of said removable handle can be detachably snapped into said first punch of said upper support rod in order to change the length of the projection of said removable handle to adapt to different heights of the user;
adjusting the length of said first lanyard, a space is formed between said first pad and said upper support rod to accommodate thighs;
a pad is provided between said lower support rod and said lower support rod, said bolt passes through the through-hole in the side wall of said lower support rod and connects with pad, fixing and connecting the curved support rod with said lower support rod, and said lower support rod rotates around a rotary axis, driving said curved support rod and said support seat to rotate and fold in the direction of said outrigger platform, facilitating the mounting, folding and dismounting of the single-leg walker.

17. A handheld single-leg walker according to claim 16, wherein said first punch is provided at least one on said upper support rod, said first punch being provided from the upper end of said upper support rod to the lower end of said upper support rod.

18. A handheld single-leg walker according to claim 1, wherein said first screwing sleeve is set on top of said upper support rod.

19. A handheld single-leg walker according to claim 1, wherein said second screwing sleeve is socketed to the bottom of said lower support rod.

20. A method of using a one-legged walker, wherein it comprises outrigger platform, and central support rod connected to both sides of outrigger platform, said central support rod is detachably connected to upper support rod at the upper end, said central support rod is detachably connected to curved support rod at the lower end, said upper support rod is connected to removable handle, and the user holds removable handle in hand while walking, said upper support rod is provided with first fastener, the height of which can be adjusted to assist the user to walk, said first fastener is connected to first connector at the other end, said first connector is connected to first lanyard at the other end, and said first lanyard is coupled to the first pad at the other end, said curved support rod is curved, said outrigger platform is provided with a projection in the lower part, said lower support rod is pivotally coupled to said projection of said outrigger platform;
said central support rod is provided with second punch at the upper end opposite to the lower end, said upper support rod is provided with first snap, said curved support rod is provided with third snap, said first snap is detachably snap-fit in second punch at the upper end of said central support rod, said third snap is detachably snap-fit in the second punch at the lower end of said central support rod, second punch at the lower end of said central support rod, said upper support rod and said curved support rod removably snap together in the second punch of the central support rod;
said upper support rod is provided with a first punch, said removable handle is provided with a first snap, said first snap of said removable handle can be detachably snapped into said first punch of said upper support rod in order to change the length of the projection of said removable handle to adapt to different heights of the user;
adjusting the length of said first lanyard, a space is formed between said first pad and said upper support rod to accommodate thighs;
the pad is provided between said lower support rod and said lower support rod, said bolt passes through the through-hole in the side wall of said lower support rod and connects with pad, fixing and connecting the curved support rod with said lower support rod, and said lower support rod rotates around a rotary axis, driving said curved support rod and said support seat to rotate and fold in the direction of said outrigger platform, facilitating the mounting, folding and dismounting of the single-leg walker;
by pressing said first snap of said removable handle, the extended length of said removable handle can be adjusted to accommodate people of different heights;
said upper support rod can be separated from said central support rod by pressing said second snap of said upper support rod;
by pressing said fourth snap of said lower connecting rod, the length of the projection of said lower connecting rod can be adjusted to accommodate people of different heights;
by pressing said third snap of said curved support rod, said lower support rod can be separated from said central support rod, and said lower support rod rotates around a pivot axis to fold said lower support rod together with said curved support rod towards the outrigger platform.
